(19) United States
(12) Patent Application Publication
(10) Pub. No.: US 2020/0406345 A1
(43) Pub. Date: Dec. 31, 2020

(54) Powder and Additive Production Method for a Workpiece Made of Said Powder

(71) Applicant: SIEMENS AKTIENGESELLSCHAFT, München (DE)

(72) Inventor: Christoph HEINZE, Berlin (DE)

(73) Assignee: Siemens Aktiengesellschaft, München (DE)

(21) Appl. No.: 16/646,701

(22) PCT Filed: Sep. 25, 2018
(86) PCT No.: PCT/EP2018/075847

§ 371 Date: Mar. 12, 2020

(30) Foreign Application Priority Data
Sep. 26, 2017 (DE) 10 2017 217 082.4

(51) Int. Cl. B22F 1/00; B22F 3/105

(52) U.S. Cl. CPC B22F 1/0011; B33Y 80/00; B22F 2301/20; B22F 3/1055

(57) ABSTRACT

Various embodiments include a powder comprising: a molybdenum, silicon, and boron alloy of the type Mo(x)Si(y)B; and a fourth constituent selected from the group consisting of: titanium having an alloying fraction of at least 1 at % and at most 30 at %, hafnium having an alloying fraction of at least 1 at % and at most 10 at %, niobium having an alloying fraction of at least 15 at % and at most 25 at %, and iron having an alloying fraction of at least 1.5 at % and at most 1.9 at %. The alloying fraction x of silicon is at least 8 at % and at most 19 at %, and the alloying fraction y of boron is at least 5 at % and at most 13 at %.

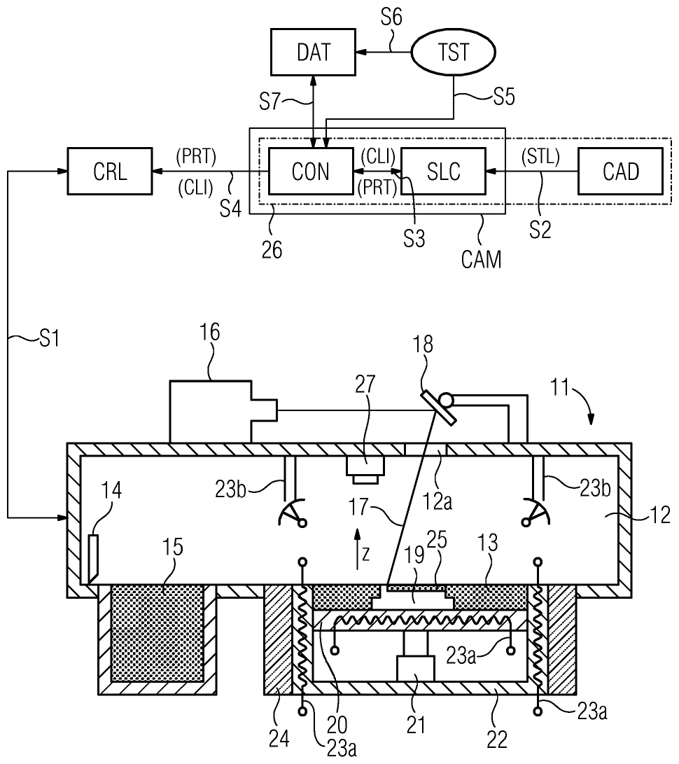

### CROSS-REFERENCE TO RELATED APPLICATIONS

This application is a U.S. National Stage Application of International Application No. PCT/EP2018/075847 filed Sep. 25, 2018, which designates the United States of America, and claims priority to DE Application No. 10 2017 217 082.4 filed Sep. 26, 2017, the contents of which are hereby incorporated by reference in their entirety.

### TECHNICAL FIELD

The present disclosure relates to powders and processes for producing a workpiece using powders, wherein a powder bed-based additive manufacturing process is employed. In said process the powder is melted by an energy beam in powder layers of a powder bed to produce the consecutive layers of the workpiece.

### BACKGROUND

Molybdenum-silicon-boron alloys are known for example from EP 1 664 362 B1. These alloys form a microstructure consisting of intermetallic phases such as molybdenum silicide and molybdenum boron silicide and molybdenum boride, wherein the total content of the intermetallic phases may be between 25 and 90 vol % and the rest of the microstructure consists of molybdenum or a molybdenum mixed crystal. These alloys may be used for high temperature applications on account of their mechanical strength properties.

One use may be for components of gas turbines subjected to high thermal stress for example, as is apparent from DE 10 2015 209 583 A1.

DE 10 2015 209 583 A1 also describes that the processing of the recited alloys may be carried out by powder metallurgy processes (for example hot pressing) or by zone melting processes. In order also to allow production of components having complex geometries it is also proposed that a powder made of the recited alloy may be used in an additive production process by layerwise application of the powder and selective consolidation via an energy beam.

In the context of this disclosure additive manufacturing processes are to be understood as meaning processes where the material from which a component is to be produced is added to the component during its formation. This causes the component to be formed already in its final state or at least approximately in this state.

In order to be able to produce the component, data describing the component (CAD model) are prepared for the chosen additive manufacturing process. In order to provide instructions for the manufacturing plant the data are converted into manufacturing process-adapted data for a workpiece to be produced so that the suitable process steps for successive production of this workpiece may be performed in the manufacturing plant. To this end the data are prepared such that the geometric data for the layers (slices) of the workpiece to be respectively produced are available, also known as slicing. The workpiece may have a shape which deviates from the component. For example, a component warping that occurs as a consequence of manufacture may be accounted for and compensated by a deviating workpiece geometry. The workpiece normally also comprises support structures which need to be removed again in a postprocessing of the component.

Examples of additive manufacturing include selective laser sintering (SLS), selective laser melting (SLM) and electron beam melting (EBM). These processes are especially suitable for processing of metallic materials in the form of powders which may be used to produce construction components. In SLM, SLS and EBM the components are produced layerwise in a powder bed. These processes are therefore also referred to as powder bed-based additive manufacturing processes. In each case a layer of the powder is produced in the powder bed which is then locally melted or sintered via the energy source (laser or electron beam) in the regions in which the component is to be formed. The component is thus produced successively in layerwise fashion and may be removed from the powder bed once complete.

### SUMMARY

Some embodiments of the teachings herein include a powder consisting of a molybdenum-, silicon- and boron-containing alloy of the type Mo(x)Si(y)B, wherein the alloying fraction x of silicon is at least 8 at % and at most 19 at %, e.g. at least 10 at % and at most 15 at %, and the alloying fraction y of boron is at least 5 at % and at most 13 at %, e.g. at least 8 at % and at most 12 at %, characterized in that additionally provided in the alloy is a fourth alloying element consisting of titanium having an alloying fraction of at least 1 at % and at most 30 at %, e.g. of at least 5 at % and at most 10 at %, or consisting of hafnium having an alloying fraction of at least 1 at % and at most 10 at %, e.g. of at least 5 at % and at most 8 at %, or consisting of niobium having an alloying fraction of at least 15 at % and at most 25 at %, e.g. of at least 17 at % and at most 21 at %, or consisting of iron having an alloying fraction of at least 1.5 at % and at most 1.9 at %.

In some embodiments, the fourth alloying element consists of hafnium having an alloying fraction of at least 1 at % and at most 10 at %, e.g. of at least 5 at % and at most 8 at %, or consists of iron having an alloying fraction of at least 1.5 at % and at most 1.9 at % and a fifth alloying element consisting of titanium having an alloying fraction of at least 1 at % and at most 30 at %, e.g. of at least 5 at % and at most 10 at %, is provided in the alloy.

In some embodiments, the fourth alloying element consists of niobium having an alloying fraction of at least 15 at % and at most 25 at %, e.g. of at least 17 at % and at most 21 at %, and a fifth alloying element consisting of hafnium having an alloying fraction of at least 1 at % and at most 10 at %, e.g. of at least 5 at % and at most 8 at %, or consisting of titanium having an alloying fraction of at least 1 at % and at most 30 at %, e.g. of at least 5 at % and at most 10 at %, is provided in the alloy.

In some embodiments, the fourth alloying element consists of titanium having an alloying fraction of at least 1 at % and at most 30 at %, e.g. of at least 5 at % and at most 8 at %, and a fifth alloying element consisting of hafnium having an alloying fraction of at least 1 at % and at most 10 at %, e.g. of at least 5 at % and at most 8 at %, and a sixth alloying element consisting of niobium having an alloying fraction of at least 15 at % and at most 25 at %, e.g. of at least 17 at % and at most 21 at %, is provided in the alloy, wherein a seventh alloying element consisting of iron having an alloying fraction of at least 1.5 at % and at most 1.9 at % is additionally provided in the alloy.

In some embodiments, the particle size of the powder is at least 10 μm and at most 45 μm, e.g. with a D50 size distribution based on mass of at least 17 μm and at most 27 μm.

As another example, some embodiments include the use of a powder as described above in a powder bed-based additive manufacturing process in which the powder is melted by an energy beam (17) in powder layers (25) of a powder bed (13) to produce consecutive layers of a workpiece (19).

As another example, some embodiments include a process for producing a workpiece (19) using a powder consisting of a molybdenum-, silicon- and boron-containing alloy of the type Mo (x) Si (y) B, wherein the alloying fraction x of silicon is at least 8 at % and at most 19 at %, e.g. at least 10 at % and at most 15 at %, and the alloying fraction y of boron is at least 5 at % and at most 13 at %, e.g. at least 8 at % and at most 12 at %, in a powder bed-based additive manufacturing process in which the powder is consolidated by an energy beam (17) in powder layers (25) of a powder bed (13) to produce consecutive layers of a workpiece (19), characterized in that the powder bed (13) is heated to a temperature level at least 50° C. above the brittle-to-ductile transition temperature of the alloy of the powder.

In some embodiments, the brittle-to-ductile transition temperature is determined by testing a sample produced from the powder with the powder bed-based additive manufacturing process.

In some embodiments, a four-point bending sample is produced as the sample.

In some embodiments, the powder bed (13) is heated to a temperature level of at least 700° C., in particular at least 1000° C.

In some embodiments, the temperature of the powder bed (13) is kept at the temperature level in a depth range extending from a surface of the powder bed (13) down to a depth of the powder bed (13) of between 100 μm and 500 μm.

In some embodiments, the temperature of the powder bed is kept at the temperature level in a depth range extending from a surface of the powder bed down to a depth of the powder bed corresponding to five times to ten times the layer thickness of the powder layers (25).

In some embodiments, as the additive manufacturing process a selective laser melting is employed with a scanning rate of the energy beam (17) of at least 500 mm/s and at most 2000 mm/s, e.g. of at least 800 mm/s and at most 1200 mm/s, with a laser power of at least 125 W and at most 250 W, e.g. of at least 150 W and at most 250 W, with a track spacing of at least 60 and at most 130 μm, e.g. of at least 80 and at most 120 μm, and with a layer thickness of the powder layers (25) of at least 20 μm and at most 50 μm.

### BRIEF DESCRIPTION OF THE DRAWINGS

The sole FIGURE shows one embodiment of a process incorporating teachings of the present disclosure executed in a laser melting plant shown in cross section.

### DETAILED DESCRIPTION

Problems arise in the additive production of components made of molybdenum-silicon-boron alloys. The additively manufactured components then exhibit cracks or do not achieve the required mechanical strengths. The teachings of the present disclosure include powders and processes for additive production of components from this powder, by which additive workpieces may be obtained in high quality, especially with improved mechanical properties.

Some embodiments of the teachings herein include a power having a fourth alloying element in the alloy. This is either titanium having an alloying fraction of at least 1 at % and at most 30 at %, e.g. of at least 5 at % and at most 10 at %, or hafnium having an alloying fraction of at least 1 at % and at most 10 at %, e.g. of at least 5 at % and at most 8 at %, or niobium having an alloying fraction of at least 15 at % and at most 25 at %, e.g. of at least 17 at % and at most 21 at %, or iron having an alloying fraction of at least 1.5 at % and at most 1.9 at %. With regard to the alloying fractions of silicon and boron, the remaining alloying fraction is molybdenum which together with any impurities and further alloying elements (see below for more) makes up the alloy to 100 at %.

The co-alloying of titanium or hafnium or niobium provides that components produced from the alloy exhibit an improved creep resistance. In particular the powder may be processed using a powder bed-based additive manufacturing process, thus achieving in accordance with the invention the object directed to the use. The co-alloying of iron in particular also improves the oxidation resistance of the alloy.

In some embodiments, in a powder bed-based additive production process for processing, the powder bed is heated to a temperature level at least 50° C. above the brittle-to-ductile transition temperature (BDTT for short) of the alloy of the powder. This is because it has been found that the mechanical quality problems of the additively produced components, in particular the propensity for crack formation, may be reduced when a cooling of the workpiece in production to a temperature level below the BDTT is reliably prevented. The established temperature level provides with a temperature range of 50° C. above the BDTT a buffer zone to reliably prevent transition of the ductile properties of the microstructure of the produced workpiece to a brittle behavior. Stresses in the workpiece occurring as a consequence of manufacture due to the temperature gradients occurring in the workpiece therefore advantageously do not initiate any (or at least initiate fewer) cracks in the microstructure. After completion of the workpiece this can then cool with a more homogeneous temperature distribution since local heating by the energy beam is no longer required for consolidation of the powder.

By contrast it has been found that rapid cooling of the melt bath during production favors the formation of the desired microstructure in the workpiece. A fiber-matrix microstructure is formed, thus improving the mechanical properties of the microstructure. The microstructure consists of individual phases of a molybdenum matrix Moss, molybdenum silicide Mo₃Si, molybdenum boron silicide Mo₅SiB₂ and further silicides (Mo,X)₅Si₃. The molybdenum matrix consists of molybdenum or a molybdenum mixed crystal. The silicides are e.g. in fibrous form as crystalline excretions. The alloying element X is provided by titanium and/or hafnium and/or niobium depending on the alloying composition (see below for more).

In some embodiments, the fourth alloying element consists of hafnium having an alloying fraction of at least 1 at % and at most 10 at %, e.g. of at least 5 at % and at most 8 at %, or consists of iron having an alloying fraction of at least 1.5 at % and at most 1.9 at % and additionally a fifth alloying element is provided. This consists of titanium having an alloying fraction of at least 1 at % and at most 30 at %, e.g. of at least 5 at % and at most 10 at %. In addition to the previously mentioned creep resistance the alloying elements hafnium and titanium especially also improve the fracture toughness and the oxidation resistance of the workpiece while the alloying element iron especially improves oxidation resistance. These properties are of paramount importance for operation of a component produced from the workpiece at high temperatures. A high fracture toughness improves the properties of the component, mechanical stress peaks without resisting initiation of cracks. Oxidation resistance is important especially for turbine components exposed to hot gases. Creep resistance especially prevents deformation of rotating components on account of the centrifugal forces encountered.

In some embodiments, the fourth alloying element consists of niobium having an alloying fraction of at least 15 at % and at most 25 at %, e.g. of at least 17 at % and at most 21 at %. Also provided is a fifth alloying element which consists of hafnium having an alloying fraction of at least 1 at % and at most 10 at %, e.g. of at least 5 at % and at most 8 at %, or of titanium having an alloying fraction of at least 1 at % and at most 30 at %, e.g. of at least 5 at % and at most 10 at %. In addition to the creep resistance of the component, niobium also improves its general strength. Thus if niobium is combined with one of the alloying elements hafnium and titanium the profile of requirements may be positively influenced in terms of strength, fracture toughness, oxidation resistance and creep resistance of the component.

In some embodiments, such a profile of properties is also achievable by a composition of the powder in which the fourth alloying element consists of titanium having an alloying fraction of at least 1 at % and at most 30 at %, e.g. at least 5 at % and at most 10 at %, and a fifth alloying element consists of hafnium having an alloying fraction of at least 1 at % and at most 10 at %, e.g. of at least 5 at % and at most 8 at %, and a sixth alloying element consists of niobium having an alloying fraction of at least 15 at % and at most 25 at %, e.g. of at least 17 at % and at most 21 at %, wherein a seventh alloying element consisting of iron having an alloying fraction of at least 1.5 at % and at most 1.9 at % is e.g. additionally provided in the alloy. Simultaneous co-alloying of titanium, Ti, and hafnium, Hf, and niobium, Nb, and optionally iron, Fe, thus results in an elevation of the strength (Nb), fracture toughness (Ti, Hf), oxidation resistance (Hf, Ti, Fe) and creep resistance (Nb, Ti, Hf) of the alloy, as a result of which the profile of requirements of thermally and mechanically highly stressed components such as turbine blades is optimally adapted.

Through choice of the alloying fractions according to the characteristics recited above the profile of properties of the components produced from the powder may thus be adapted to the specifications of the respective application. Important here are the intended purpose and in particular also the usage temperature since the usage temperature must be above the BDTT in order for the component to exhibit ductile material behavior.

The BDTT of a component also depends not least on the microstructure established in the component. In some embodiments, the BDTT is determined by testing a sample produced with the powder bed-based additive manufacturing process from the powder to be used for the component. A four-point bending sample may in particular be produced as a sample. This may then be analyzed in a four-point bending test to determine the ductility of the sample. BDTT may be determined by testing the samples at different temperatures to determine the temperature at which a change between ductile and brittle properties of the microstructure takes place. In the four-point bending test a test piston with two pressure points stresses a sample placed on two points. There is a constant bending moment between the support points. Other bending tests such as for example a three-point bending test or a two-point bending test are also performable as an alternative. In a three-point bending test the sample is supported at both ends and stressed by a test piston in the middle. Frictional and torsional stresses on the samples must be minimized here. For the two-point bending test a test piston stresses the free side of a sample clamped at one end.

Another option is that of heating the powder bed to a temperature level of at least 700° C., in particular at least 1000° C. Above this temperature level it may be assumed that the bed is above the BDTT. A temperature level in this range may be chosen for example to produce samples for determining the BDTT. In later uses of the powder the determined BDTT may then be used as a basis in order that the heating of the powder bed takes place only as far as necessary. This saves energy and shortens heating times, thus making performance of the process more economic.

In some embodiments, the temperature of the powder bed is kept at the recited temperature level in a depth range extending from a surface of the powder bed down to a depth of the powder bed of 100 μm to 500 μm. In other words, this depth range extends from the surface to between 100 μm and 500 μm into the depth of the powder bed. This is because it has been found that it is not necessary to temperature-control the entire powder bed to prevent the occurrence of stress cracks during production. It is sufficient to reduce the local temperature gradient in the near-surface region of the already produced workpiece.

In some embodiments, the depth range may be determined with reference to the layer thickness of the powder layer. Accordingly the depth range extends from the surface of the powder bed down to a depth of the powder bed corresponding to five times to ten times the layer thickness of the powder layers.

Further particulars of the teachings herein are described hereinbelow with reference to the drawing. Identical or corresponding drawing elements are in each case provided with identical reference numerals and are elucidated more than once only to the extent that there are differences between the individual FIGURES. In the working examples the described components of the embodiments each represent individual features of the teachings herein to be regarded independently of one another which each also develop the teachings independently of one another and are thus also to be regarded as a constituent of the teachings individually or in a combination other than the recited combination. The described embodiments may also be augmented with further of the above-described features of the disclosure.

The sole FIGURE shows a schematic view of a plant 11 for laser melting. Said plant comprises a process chamber 12 having a window 12a in which a powder bed 13 may be produced. To produce a respective layer of the powder bed 13 a spreading device in the form of a doctor blade 14 is moved over a powder reservoir 15 and subsequently over the powder bed 13, thus forming a thin layer of powder in the powder bed 13 which forms an uppermost layer 25 of the powder bed. A laser 16 then produces a laser beam 17 which by means of an optical deflection apparatus comprising mirror 18 passes through the window 12a into the process chamber 12 and is moved over the surface of the powder bed 13. This melts the powder at the point of impact of the laser beam 17 to form a workpiece 19.

The powder bed 13 is formed on a construction platform 20 which via an actuator 21 in a pot-shaped housing 22 may be lowered stepwise in each case by a powder layer thickness. Provided in the housing 22 and the construction platform 20 are heating means 23a in the form of electrical resistance heating means (induction coils, not shown, are alternatively also possible) which can preheat the incipient workpiece 19 and the particles of the powder bed 13. In some embodiments, infrared radiators may also be arranged in the process chamber 12 as heating means 23b to irradiate and thus heat the surface of the powder bed 13. In order to limit the energy requirements for preheating the housing 22 has an external insulation 24 with low thermal conductivity. The temperature at the surface of the powder 13 may be determined using a thermal imaging camera 27 in order to adapt the heating power of the heating means 23a, 23b as required. Temperature sensors (not shown) may also be used at the powder bed alternatively to the thermal imaging camera 27.

The plant 11 for laser melting is controlled via a first interface S1 by a control means CRL which must first be provided with suitable process data. This may be done using a computer program product 26 which consists of a plurality of program modules. To prepare for the production of the workpiece 19 it is first necessary to generate the three-dimensional geometry data of the workpiece in a construction program module CAD. The thus-generated geometry dataset STL (for example an STL file) is via a second interface S2 transferred to a system for manufacturing preparation CAM. Installed on the system for manufacturing preparation CAM are a generation program module CON and a transformation program module SLC. The generation program module CON and the transformation program module SLC communicate with one another via a third interface S3. In the transformation program module SLC the construction dataset STL (received via the second interface S2) is transformed into a manufacturing dataset CLI (for example a CLI file) which describes the workpiece 19 in the layers to be produced. This transformation process is also referred to as slicing. The generation program module CON is additionally used to specify process parameters PRT which also influence the generation of the manufacturing dataset CLI and together therewith via a fourth interface S4 are passed to the control means CRL. Concerned here are manufacturing parameters which may be converted by the control means CRL into machine commands for the plant 11.

In the determination of the process parameters PRT, the generation program module CON also accounts for results determined by four-point bending tests in the context of test methods TST by analysis of samples previously produced by additive manufacturing. For a certain alloy type these are for example the BDTT determined with the produced four-point bending samples for particular process parameters of the additive manufacturing process. These may be provided to the generation program module CON via an interface S7 via an interface S5. These test results may simultaneously be provided to a databank DAT via an interface S6. The databank DAT is likewise connected to the generation program module CON so that reference may be made to previously generated measured results and the accompanying process parameters and alloying compositions without requiring new analyses for each component.

It is possible to operate with a scanning rate of the laser beam of at least 500 mm/s and at most 2000 mm/s, e.g. of at least 800 mm/s and at most 1200 mm/s, with a laser power of at least 125 W and at most 250 W, e.g. of at least 150 W and at most 250 W, with a track spacing of at least 60 and at most 130 μm, e.g. of at least 80 and at most 120 μm, and with a layer thickness of the powder layers of at least 20 μm and at most 50 μm.

A powder having particle sizes of at least 10 μm and at most 45 μm may be used for laser melting, wherein a size distribution D50 (i.e. 50% of the particles are smaller than this value) is at least 17 μm and at most 27 μm. Powders having such a size distribution are readily producible with powder bed-based additive manufacturing processes since they may be reliably metered into the powder bed.

What is claimed is:

1-13. (canceled)

14. A powder comprising:
a molybdenum, silicon, and boron alloy of the type Mo(x)Si(y)B;
wherein the alloying fraction x of silicon is at least 8 at % and at most 19 at %, and the alloying fraction y of boron is at least 5 at % and at most 13 at %; and
a fourth constituent selected from the group consisting of: titanium having an alloying fraction of at least 1 at % and at most 30 at %, hafnium having an alloying fraction of at least 1 at % and at most 10 at %, niobium having an alloying fraction of at least 15 at % and at most 25 at %, and iron having an alloying fraction of at least 1.5 at % and at most 1.9 at %.

15. The powder as claimed in claim 14, wherein the fourth constituent comprises at least one of: hafnium having an alloying fraction of at least 1 at % and at most 10 at %, or iron having an alloying fraction of at least 1.5 at % and at most 1.9 at %; and the powder further comprises titanium having an alloying fraction of at least 1 at % and at most 30 at %.

16. The powder as claimed in claim 14, wherein the fourth constituent comprises niobium having an alloying fraction of at least 15 at % and at most 25 at %; and the powder further comprises a fifth constituent including at least one of hafnium having an alloying fraction of at least 1 at % and at most 10 at %, or titanium having an alloying fraction of at least 1 at % and at most 30 at %.

17. The powder as claimed in claim 14, wherein the fourth constituent comprises titanium having an alloying fraction of at least 1 at % and at most 30 at %; and
the powder further comprises hafnium having an alloying fraction of at least 1 at % and at most 10 at %; and
niobium having an alloying fraction of at least 15 at % and at most 25 at %; and
iron having an alloying fraction of at least 1.5 at % and at most 1.9 at %.

18. The powder as claimed in claim 14, wherein the particle size of the powder is at least 10 μm and at most 45 μm.

19. A method comprising:
using a powder a powder bed-based additive manufacturing process;
melting the powder using an energy beam in powder layers of a powder bed to produce consecutive layers of a workpiece;
wherein the powder comprises:
a molybdenum, silicon, and boron alloy of the type Mo(x)Si(y)B;
wherein the alloying fraction x of silicon is at least 8 at % and at most 19 at %, and the alloying fraction y of boron is at least 5 at % and at most 13 at %; and
a fourth constituent selected from the group consisting of: titanium having an alloying fraction of at least 1 at % and at most 30 at %, hafnium having an alloying fraction of at least 1 at % and at most 10 at %, niobium having an alloying fraction of at least 15 at % and at most 25 at %, and iron having an alloying fraction of at least 1.5 at % and at most 1.9 at %.

20. A method for producing a workpiece, the method comprising:
using a powder consisting of a molybdenum-, silicon- and boron-containing alloy of the type Mo(x)Si(y)B, wherein the alloying fraction x of silicon is at least 8 at % and at most 19 at %, and the alloying fraction y of boron is at least 5 at % and at most 13 at %, in a powder bed-based additive manufacturing process;
wherein the powder is consolidated by an energy beam in powder layers of a powder bed to produce consecutive layers of a workpiece;
heating the powder bed to a temperature level at least 50° C. above the brittle-to-ductile transition temperature of the alloy of the powder.

21. The process as claimed in claim 20, including determining the brittle-to-ductile transition temperature by testing a sample produced from the powder with the powder bed-based additive manufacturing process.

22. The process as claimed in claim 21, including producing a four-point bending sample.

23. The process as claimed in claim 20, further comprising heating the powder bed to a temperature level of at least 700° C.

24. The process as claimed in claim 20, further comprising keeping a temperature of the powder bed at a temperature level in a depth range extending from a surface of the powder bed down to a depth of the powder bed of between 100 μm and 500 μm.

25. The process as claimed in claim 20, further comprising keeping a temperature of the powder bed at a temperature level in a depth range extending from a surface of the powder bed down to a depth of the powder bed corresponding to five times to ten times the layer thickness of the powder layers.

26. The process as claimed in claim 20, further comprising as the additive manufacturing process a selective laser melting is employed with a scanning rate of the energy beam of at least 500 mm/s and at most 2000 mm/s, with a laser power of at least 125 W and at most 250 W, with a track spacing of at least 60 and at most 130 μm, and with a layer thickness of the powder layers of at least 20 μm and at most 50 μm.
